(19) United States
(12) Patent Application Publication
(10) Pub. No.: US 2026/0095284 A1
(43) Pub. Date: Apr. 2, 2026

(54) METHOD AND APPARATUS OF SUPPORTING BEAM FAILURE RECOVERY

(71) Applicant: LENOVO (BEIJING) LIMITED, Beijing (CN)

(72) Inventors: Wei Ling, Beijing (CN); Yi Zhang, Beijing (CN); Chenxi Zhu, Beijing (CN); Bingchao Liu, Beijing (CN); Lingling Xiao, Beijing (CN)

(21) Appl. No.: 19/110,477

(22) PCT Filed: Dec. 29, 2022
(86) PCT No.: PCT/CN2022/143362

§ 371 Date: Mar. 11, 2025

(51) Int. Cl. H04L 5/00; H04B 7/06; H04W 72/23

(52) U.S. Cl. CPC H04L 5/0048; H04B 7/0695; H04L 5/0053; H04L 5/0094; H04W 72/23

(57) ABSTRACT

Embodiments of the present application relate to a method and apparatus of supporting beam failure recovery. An exemplary method includes: receiving a signaling indicating at least one joint or downlink TCI state for downlink channel in a BWP of a serving cell, wherein two or more NBI-RS sets and two or more BFD-RS sets are configured in the BWP and are one to one associated, and zero RS or at least one RS for each BFD-RS set will be determined from the at least one joint or downlink TCI state; and determining one BFD-RS set according to a joint or downlink TCI state of the at least one joint or downlink TCI state in the case that a number of the at least one joint or downlink TCI state is one or only the joint or downlink TCI state is applied for CORESETs in the BWP.

### TECHNICAL FIELD

Embodiments of the present application generally relate to wireless communication technology, and in particular to a method and an apparatus of supporting beam failure recovery (BFR), e.g., in scenarios of multiple transmit-receive points (TRPs) (multi-TRP or M-TRP).

### BACKGROUND

Multi-TRP/panel transmission has been introduced into new radio (NR) since Release 16 (R16), and enhancements on multiple-input multiple-output (MIMO) for NR have been discussed, for example in RP-182067. During multi-TRP transmission, two or more TRPs (or panels) may be used to transmit data to a user equipment (UE) to improve reliability and robustness. A work item description (WID) approved on MIMO in NR Release 18 (Rel-18) extends unified transmission configuration indication (TCI) framework into multi-TRP use cases as the following: specify extension of Rel-17 unified TCI framework for indication of multiple downlink (DL) and uplink (UL) TCI states focusing on multi-TRP use cases, using Rel-17 unified TCI framework.

Thus, there are various technical problems to be solved to support multi-TRP (and/or multi-panel) transmission under unified TCI framework, e.g., BFR in single-downlink control information (S-DCI) based M-TRP considering TRP-specific BFR. It is desirable to improve technology for BFR in S-DCI based M-TRP.

### SUMMARY OF THE APPLICATION

An objective of the present application is to provide a technical solution of supporting beam failure recovery, e.g., enhanced BFR in S-DCI based M-TRP considering TRP-specific BFR.

Some embodiments of the present application provide a wireless communication apparatus, e.g., a UE, which includes: a transceiver; and a processor coupled to the transceiver, wherein the processor is configured to: receive a signaling indicating at least one joint or downlink TCI state for downlink channel in a bandwidth part (BWP) of a serving cell, wherein two or more new beam indicator (NBI)-resource signal (RS) sets and two or more beam failure detection (BFD)-RS sets are configured in the BWP, the two or more NBI-RS sets and the two or more BFD-RS sets are one to one associated, and zero RS or at least one RS for each BFD-RS set will be determined from the at least one joint or downlink TCI state; and determine one BFD-RS set according to a joint or downlink TCI state of the at least one joint or downlink TCI state in the case that a number of the at least one joint or downlink TCI state is one or only the joint or downlink TCI state is applied for control resource sets (CORESETs) in the BWP, wherein the determined one BFD-RS set is one of the two or more BFD-RS sets or different from any one of the two or more BFD-RS sets.

Some embodiments of the present application also provide a method of supporting BFR, e.g., performed in a UE, which includes: receiving a signaling indicating at least one joint or downlink TCI state for downlink channel in a BWP of a serving cell, wherein two or more NBI-RS sets and two or more BFD-RS sets are configured in the BWP, the two or more NBI-RS sets and the two or more BFD-RS sets are one to one associated, and zero RS or at least one RS for each BFD-RS set will be determined from the at least one joint or downlink TCI state; and determining one BFD-RS set according to a joint or downlink TCI state of the at least one joint or downlink TCI state in the case that a number of the at least one joint or downlink TCI state is one or only the joint or downlink TCI state is applied for CORESETs in the BWP, wherein the determined one BFD-RS set is one of the two or more BFD-RS sets or different from any one of the two or more BFD-RS sets.

In some embodiments of the present application, the at least one joint or downlink TCI state is associated with a same TRP or different TRPs, and different TRPs are associated with different BFD-RS sets of the two or more BFD-RS sets. In some cases, each TRP is associated with a TCI state group or a CORESET group.

In some embodiments of the present application, the determined one BFD-RS set is one of the two or more BFD-RS sets associated with the joint or downlink TCI state and includes at least one RS determined according to the joint or downlink TCI state, other BFD-RS sets of the two or more BFD-RS sets are not associated with the joint or downlink TCI state and include zero RS, and the processor is configured to set beam failure instance (BFI) counters of the other BFD-RS sets to 0. In some cases, the processor is further configured to perform a beam failure recovery procedure for the determined one BFD-RS set in a manner as the same as that performed in the case that each of the two or more BFD-RS sets is associated with an indicated TCI state.

In some embodiments of the present application, the determined one BFD-RS set is one of the two or more BFD-RS sets associated with the joint or downlink TCI state and includes at least one RS determined according to the joint or downlink TCI state, other BFD-RS sets of the two or more BFD-RS sets are not associated with the joint or downlink TCI state and include zero RS, and the processor is configured to initiate a random access procedure on the serving cell in the case that a beam failure recovery procedure is triggered for the determined one BFD-RS set and the serving cell is a special cell (SpCell).

In some embodiments of the present application, the determined one BFD-RS set is different from any one of the two or more BFD-RS sets, each of the two or more BFD-RS sets includes zero RS, and the processor is configured to set BFI counters of the two or more BFD-RS sets to 0. In some cases, the processor is further configured to perform a beam failure recovery procedure for the determined one BFD-RS set in the serving cell in a manner as the same as that performed in the case that only one BFD-RS set is configured in the serving cell.

Some other embodiments of the present application provide a wireless communication apparatus, e.g., a radio access network (RAN) node, which includes: a transceiver; and a processor coupled to the transceiver, wherein the processor is configured to: transmit a signaling indicating at least one joint or downlink TCI state for downlink channel in a BWP of a serving cell, wherein two or more NBI-RS sets and two or more BFD-RS sets are configured in the BWP, the two or more NBI-RS sets and the two or more BFD-RS sets are one to one associated, and zero RS or at least one RS for each BFD-RS set will be determined from the at least one joint or downlink TCI state; and determine one BFD-RS set according to a joint or downlink TCI state of the at least one joint or downlink TCI state in the case that a number of the at least one joint or downlink TCI state is one or only the joint or downlink TCI state is applied for CORESETs in the BWP, wherein the determined one BFD-RS set is one of the two or more BFD-RS sets or different from any one of the two or more BFD-RS sets.

In some embodiments of the present application, the determined one BFD-RS set is one of the two or more BFD-RS sets associated with the joint or downlink TCI state and includes at least one RS determined according to the joint or downlink TCI state, other BFD-RS sets of the two or more BFD-RS sets are not associated with the joint or downlink TCI state and include zero RS, and the processor is configured to set BFI counters of the other BFD-RS sets to 0. The processor is further configured to only detect beam failure recovery report for the determined one BFD-RS set in a manner as the same as that performed for a BFD-RS set in the case that each of the two or more BFD-RS sets is associated with an indicated TCI state.

In some embodiments of the present application, the determined one BFD-RS set is one of the two or more BFD-RS sets associated with the joint or downlink TCI state and includes at least one RS determined according to the joint or downlink TCI state, other BFD-RS sets of the two or more BFD-RS sets are not associated with the joint or downlink TCI state and include zero RS, and the processor is configured to detect a random access procedure on the serving cell in the case that a beam failure recovery procedure is triggered for the determined one BFD-RS set and the serving cell is a SpCell.

In some embodiments of the present application, the determined one BFD-RS set is different from any one of the two or more BFD-RS sets, each of the two or more BFD-RS sets includes zero RS, and the processor is configured to set BFI counters of the two or more BFD-RS sets to 0. In some cases, the processor is further configured to only detect beam failure recovery report for the determined one BFD-RS set in the serving cell in a manner as the same as that performed in the case that only one BFD-RS set is configured in the serving cell.

Given the above, embodiments of the present application at least provide a technical solution of supporting beam failure recovery, especially considering TRP-specific BFR in scenarios of S-DCI based multi-TRP transmission, which can perform BFR when only one joint or downlink TCI state is updated or only one indicated joint or downlink TCI state is applied for CORESETs and TRP-specific BFR is configured. Accordingly, embodiments of the present application will facilitate the deployment and implementation of the NR.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present application.

FIG. 2 is a flow chart illustrating a method of supporting beam failure recovery according to some embodiments of the present application.

FIG. 3 illustrates a simplified block diagram of an apparatus of supporting beam failure recovery according to some embodiments of the present application.

FIG. 4 illustrates a simplified block diagram of an apparatus of supporting beam failure recovery according to some other embodiments of the present application.

### DETAILED DESCRIPTION

The detailed description of the appended drawings is intended as a description of the preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present application are also applicable to similar technical problems; and moreover, the terminologies recited in the present application may change, which should not affect the principle of the present application.

A wireless communication system generally includes one or more base stations (BSs) and one or more UE. Furthermore, a BS may be configured with one TRP (or panel) or more TRPs (or panels). A TRP can act like a small BS. The TRPs can communicate with each other by a backhaul link. Such backhaul link may be an ideal backhaul link or a non-ideal backhaul link. Latency of the ideal backhaul link may be deemed as zero, and latency of the non-ideal backhaul link may be tens of milliseconds and much larger, e.g. on the order of tens of milliseconds, than that of the ideal backhaul link.

In a wireless communication system, a single TRP can be used to serve one or more UE under the control of a BS. In different scenarios, a TRP may be referred to as different terms. Persons skilled in the art should understand that as 3GPP and the communication technology develop, the terminologies recited in the specification may change, which should not affect the scope of the present application. It should be understood that the TRP(s) (or panel(s)) configured for the BS may be transparent to a UE.

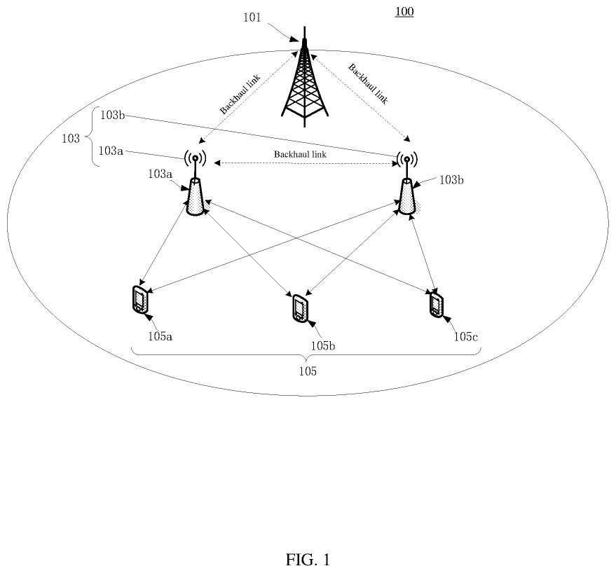

FIG. 1 is a schematic diagram illustrating an exemplary wireless communication system 100 according to some embodiments of the present application.

Referring to FIG. 1, a wireless communication system 100 can include a base station (BS) 101, TRPs 103 (e.g., a TRP 103a and a TRP 103b), and UEs 105 (e.g., a UE 105a, a UE 105b, and a UE 105c). Although only one base station 101, two TRPs 103 and three UEs 105 are shown for simplicity, it should be noted that the wireless communication system 100 may include more or less communication device(s) or apparatus in accordance with some other embodiments of the present application.

In some embodiments of the present application, a BS 101 may be referred to as an access point, an access terminal, a base, a base unit, a macro cell, a Node-B, an evolved Node B (eNB), a gNB, an ng-eNB, a Home Node-B, a relay node, or a device, or described using other terminology used in the art. The UEs 105 (for example, the UE 105a, the UE 105b, and the UE 105c) may include, for example, but is not limited to, a computing device, a wearable device, a mobile device, an IoT device, a vehicle, etc.

The TRPs 103, for example, the TRP 103a and the TRP 103b can communicate with the base station 101 via, for example, a backhaul link. Each of TRPs 103 can serve some or all of UEs 105. As shown in FIG. 1, the TRP 103a can serve some mobile stations (which include the UE 105a, the UE 105b, and the UE 105c) within a serving area or region (e.g., a cell or a cell sector). The TRP 103b can serve some mobile stations (which include the UE 105a, the UE 105b, and the UE 105c) within a serving area or region (e.g., a cell or a cell sector). The TRP 103a and the TRP 103b can communicate with each other via, for example, a backhaul link.

The multi-TRP transmission may refer to at least two TRPs (or panels) to transmit data to a UE. As shown in FIG. 1, for the same UE 105 (e.g., the UE 105a, the UE 105b, or the UE 105c), two TRPs (e.g., the TRP 103a and the TRP 103b) may both transmit data to it, which is an exemplary scenario of the multi-TRP transmission. A multi-TRP transmission scenario can also be referred to as a multi-TRP scenario or multi-panel scenario.

In addition, in Rel-15, a random access channel (RACH)-based BFR is defined for primary cell (PCell); and in R16, a media access control (MAC) control element (CE)-based BFR with physical uplink control channel scheduling request (PUCCH-SR) is defined for secondary cell (SCell). However, both the BFRs for PCell and SCell are only defined for single-TRP transmission. For multi-TRP transmission, the beam failure recovery can be performed respectively for each TRP. i.e., TRP-specific BFR, which is agreed to be supported in Rel-17 and is designed based on Rel-16 SCell BFR scheme. In an exemplary TRP-specific BFR, two failure detection resource sets which can also be named as two BFD-RS sets will be configured in a cell, wherein each failure detection resource set is associated with a TRP. In addition, two candidate resource sets which can also be named as NBI-RS sets are configured by one to one associated with the two failure detection resource sets, wherein each candidate resource set is associated with a corresponding failure detection resource set. Each resource in a failure detection resource set and candidate resource sets represent a corresponding beam.

According to BFR in S-DCI based M-TRP in feature lead summary of AI9.1.1.1 of RAN1 #111, on unified TCI framework extension for S-DCI based M-TRP, if a BFD-RS set is not explicitly provided to a UE, the UE will determine BFD-RS for the BFD-RS set from an indicated joint or downlink TCI state in the case that the indicated joint or downlink TCI state is configured to apply for physical downlink control channel (PDCCH) reception.

It can be seen, if two joint or downlink TCI states are indicated for PDCCH reception, then two BFD-RS sets are determined according to the two joint or downlink TCI states where each BFD-RS set is associated with one of the two joint or downlink TCI states. However, since the joint or downlink TCI states are indicated by a codepoint in a TCI field in a DCI, which is consistent to a TCI codepoint of a MAC CE, the number of joint or downlink TCI states will be updated from two to one in the case that the TCI codepoint(s) in the MAC CE includes only one joint or downlink TCI state. Therefore, how to perform BFR if TRP-specific BFR is configured while the number of joint or downlink TCI state is changed to one needs to be studied and solved.

At least considering the above technical problem, embodiments of the present application provide technical solutions of supporting BFR, especially in a S-DCI based multi-TRP (or multi-panel) scenario considering TRP-specific BFR.

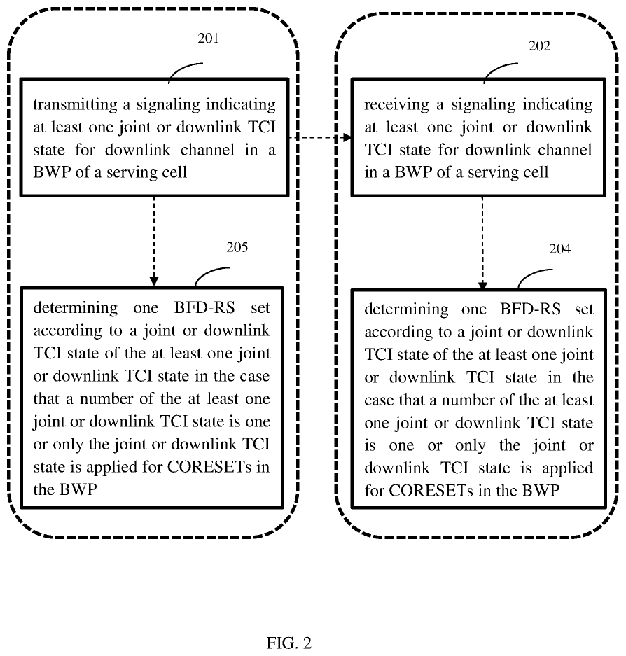

FIG. 2 is a flow chart illustrating a method of supporting beam failure recovery according to some embodiments of the present application. Although the method is illustrated in a system level by a network side, e.g., a BS 101 or the like and a remote side, e.g., a UE 105 or the like, persons skilled in the art can understand that the method implemented in the UE and that implemented in the BS can be separately implemented and incorporated by other apparatus with the like functions. In addition, it is assumed that the UE in the illustrated embodiments at least has the capability to support TRP-specific BFR.

As shown in FIG. 2, in step 201, the network side, e.g., the BS 101 (e.g., a gNB) as illustrated and shown in FIG. 1 may transmit a signaling, e.g., a DCI or a MAC CE to the remote side, e.g., the UE 105 as illustrated and shown in FIG. 1. The DCI or MAC CE indicates at least one joint or downlink TCI state for downlink channel (e.g., PDCCH) in a BWP of a serving cell. Accordingly, the remote side, e.g., the UE 105 as illustrated and shown in FIG. 1 will receive the signaling from the network side in step 202.

Herein, only S-DCI based M-TRP scenario or the like is considered. For S-DCI based M-TRP, at least one codepoint of the MAC CE activating joint or downlink TCI states includes (or contains or indicates) two joint or downlink TCI states. For example, the gNB may indicate two joint or downlink TCI state in a codepoint (e.g., TCI codepoint) of a MAC CE activating unified (or common) TCI states. In the case that more than one codepoint is included in the MAC CE, a DCI may be further indicated to the UE by the gNB, and the two joint or downlink TCI states in the TCI codepoint is indicated by the DCI. In the case that only one codepoint is included in the MAC CE, the two joint or downlink TCI states in the TCI codepoint is indicated by the MAC CE itself and no DCI is further needed. In this view, at least one joint or downlink TCI state in a TCI codepoint of a MAC CE is indicated by a DCI or MAC CE. In addition, for two joint or downlink TCI states in a codepoint, they are respectively identified as the first joint or downlink TCI state and the second joint or downlink TCI state in the codepoint in sequence in some embodiments of the present application.

According to current specifications and agreements, there are up to two TRPs in a multi-TRP scenario (or up to two panels in a multi-panel scenario), and thus two failure detection resource sets, e.g., two BFD-RS sets will be configured by explicit or implicit failure detection resource set configuration. Considering TRP-specific BFR, to detect the beam condition per TRP, separate failure detection resource set is configured for each TRP in the BWP of the serving cell in a multi-TRP (or multi-panel scenario), so that TRP-specific BFR in serving cell can be supported in the multi-TRP (or multi-panel) scenario.

Moreover, in the case of TRP-specific BFR, two candidate resource sets, e.g., two NBI-RS sets are configured for the BWP in the serving cell, which are one to one association with the two failure detection resource sets, e.g., configured by a high layer parameter candidateBeamRSList as defined in TS38.213 by radio resource control (RRC) signaling or the like. Herein, it is assumed that in the case of TRP-specific BFR being configured, two NBI-RS sets will always be configured, wherein different NBI-RS sets are one to one associated with different failure detection resource sets, e.g., BFD-RS sets regardless of implicit or explicit BFD-RS set configuration. However, only implicit BFD-RS set configuration for TRP-specific BFR is considered in embodiments of the present application, which means BFD-RS sets are not configured by RRC signaling or the like but determined according to the beam of CORESETs etc. Regarding a beam, it may be represented by a RS, e.g., CSI-RS or SSB, or spatial relationship filter. TCI state or quasi co-location (QCL) properties of demodulation reference signal (DMRS) port etc.

As the evolution of 3GPP specifications or other related specifications/protocols, in the case that there are more than two TRPs in a multi-TRP scenario, there will be more than two NBI-RS sets or the like and more than two BFD-RS sets considering TRP-specific BFR. It is similar in multi-panel scenario (hereafter, only multi-TRP scenario is illustrated as an example). Thus, although exemplary embodiments of the present application are mainly illustrated based on the current specifications and agreements, persons skilled in the art should well know how to apply the technical solution disclosed in the present application to scenarios with more than two TRPs.

The indicated at least one joint or downlink TCI state is associated with the same TRP or different TRPs. As stated above, each TRP can be represented in various manners, e.g., each TRP is associated with a TCI state group or a CORESET group. Since different TRPs are associated with different BFD-RS sets, the indicated at least one joint or downlink TCI state will be associated with the same BFD-RS set or different BFD-RS sets. Accordingly, zero RS or at least one RS for each BFD-RS set will be determined from the indicated at least one joint or downlink TCI state.

Based on the indicated joint or downlink TCI state(s), the UE will determine the BFD-RS set(s) in step 204. Similarly, in step 205, the gNB will also determine the BFD-RS set(s) according to the indicated joint or downlink TCI state(s). Accordingly, the BFD-RS set(s) will be determined to perform BFR in the case of implicit BFD-RS set configuration.

According to some embodiments of the present application, in the case that two joint or downlink TCI states are indicated, the UE will determine two BFD-RS sets according to the two joint or downlink TCI states in step 204 in various manners. Similarly, in step 205, the gNB will also determine two BFD-RS sets according to the two joint or downlink TCI states in various manners (which are consistent with the UE side). It is similar in the case that there are more BFD-RS sets and more associated TCI states are configured. TRP-specific BFR will be performed in the same way as legacy mechanism.

For example, in some embodiments of the present application, each joint or downlink TCI states activated in the MAC CE is associated with one group of two TCI state groups, wherein the TCI state groups and TRPs are one to one associated (or one to one mapping). The association between a joint or downlink TCI state and a TCI state group can be configured by RRC signaling or indicated by a MAC CE etc. Two BFD-RS sets are also one to one associated with the two TCI state groups, and the association can be predefined or configured by RRC signaling etc. For example, the first and second BFD-RS sets, e.g., BFD-RS set #0 and #1 are associated with the first and second TCI state groups, e.g., TCI state group #0 and #1 respectively.

In some other embodiments of the present application, similar to the above embodiments, each joint or downlink TCI states activated in the MAC CE is associated with one group of two TCI state groups, wherein the TCI state groups and TRPs are one to one associated (or one to one mapping). The association between a joint or downlink TCI state and a TCI state group can be configured by RRC signaling or indicated by a MAC CE etc. If the two joint or downlink TCI states are configured to be applied for different CORESETs, then the first BFD-RS set is determined according to a joint or downlink TCI state of the two joint or downlink TCI states associated with a TCI state group which is associated with the first BFD-RS set, and the second BFD-RS set is determined according to the other joint or downlink TCI state associated with another TCI state group which is associated with the second BFD-RS set, and vice visa.

In some yet other embodiments of the present application, two CORESET groups are configured, wherein each CORESET is associated with one CORESET group by a RRC signaling etc. A CORESET group may be associated with a TRP. Two BFD-RS sets are one to one associated with the two CORESET groups, and the association can be predefined or configured by RRC signaling. For example, the first and second BFD-RS sets, e.g., BFD-RS set #0 and #1 are associated with the first and second CORESET groups, e.g., CORESET group #0 and CORESET group #1, respectively. Each CORESET group has a CORESET group ID, e.g., a CORESETPoolIndex. A CORESETPoolIndex can represent a TRP in some cases.

Besides, the same joint or downlink TCI state is applied for CORESETs within the same CORESET group. In the case that two joint or downlink TCI states are indicated for downlink channels (e.g., for PDCCH), different joint or downlink TCI states are associated with different CORESET groups by RRC signaling or the like. Therefore, the first BFD-RS set is determined according to a joint or downlink TCI state of the two joint or downlink TCI states associated with a CORESET group which is associated with the first BFD-RS set, and the second BFD-RS set is determined according to the other joint or downlink TCI state associated with another CORESET group which is associated with the second BFD-RS set, and vice visa.

In the case that only one joint or downlink TCI state is indicated by DCI or MAC CE, then the beam of all related CORESETs is only associated with the indicated joint or downlink TCI state. Therefore, only one BFD-RS set associated with the indicated joint or downlink TCI state includes a RS according to the indicated joint or downlink TCI state, while the other BFD-RS set includes no RS because no joint or downlink TCI state is associated with the BFD-RS set. Similarly, in the case that even if more than one TCI state is indicated while only one of the indicated TCI states is applied for CORESETs in the BWP, similar issues also exist.

At least considering that, according to some embodiments of the present application, in the case that only one joint or downlink TCI state is indicated or only one joint or downlink TCI state of the at least one joint or downlink TCI state is applied for CORESETs in the BWP, the UE will determine one BFD-RS set according to the only one joint or downlink TCI state of the at least one joint or downlink TCI state in step 204. Similarly, in step 205, the gNB will also determine one BFD-RS set according to the only one joint or downlink TCI state of the at least one joint or downlink TCI state in the case that the number of the at least one joint or downlink TCI state is one or the only one joint or downlink TCI state is applied for CORESETs in the BWP. The determined one BFD-RS set is one of the two (or more) BFD-RS sets or different from any one of the two (or more) BFD-RS sets. Accordingly, TRP-specific BFR will be still maintained or dynamically switched to the cell-specific BFR. In the case of cell-specific BFR, it is assumed the UE also has the capability of cell-specific BFR besides the TRP-specific BFR.

For example, according to some embodiments of the present application, TRP-specific BFR is still maintained. The determined one BFD-RS set is one of the two (or more) BFD-RS sets associated with the only one joint or downlink TCI state of the at least one joint or downlink TCI state and includes at least one RS determined according to the only one joint or downlink TCI state. Other BFD-RS sets of the two (or more) BFD-RS sets are not associated with the only one joint or downlink TCI state and include zero RS, and the BFI counters, e.g., BFI_COUNTER of the other BFD-RS sets is set to 0. That is, one BFD-RS set associated with a TRP (e.g., a TCI state group or a CORESET group) associated with the only one joint or DL TCI state is determined according to the only one joint or downlink TCI state and includes at least one RS associated with the only one joint or downlink TCI state. While there is no RS in the other (or remaining) BFD-RS set(s).

Then, the UE will perform a beam failure recovery procedure for the determined one BFD-RS set in a manner as the same as that performed in the case that each of the two (or more) BFD-RS sets is associated with an indicated TCI state (e.g., as legacy TRP-specific BFR in the corresponding TRP). For example, the UE will stop the beam failure detection of the other BFD-RS set, and only perform the beam failure recovery procedure for the BFD-RS set determined by the only one joint or DL TCI state by using the TRP-specific BFR procedure. If BFR is triggered, PUCCH-SR is transmitted to request uplink grant to transmit BFR MAC CE. Correspondingly, the gNB will stop the beam failure detection of the other BFD-RS set, and only detect beam failure recovery report for the determined one BFD-RS set in a manner as the same as that performed for a BFD-RS set in the case that each of the two (or more) BFD-RS sets is associated with an indicated TCI state (e.g., as legacy TRP-specific BFR in the corresponding TRP). If PUCCH SR is received from the UE, which requests uplink grant to transmit BFR MAC CE, the gNB will transmit the requested uplink grant to the UE.

In short, after the number of indicated joint or downlink TCI state for downlink channels is changed to one by a DCI or a MAC CE, the BFI counter of a BFD-RS set which includes no RS will be set (or reset) to 0. For the BFD-RS set associated with the only one joint or downlink TCI state, it will follow the legacy procedure, e.g., using PUCCH-SR and BFR MAC CE to recover the beam associated with the BFD-RS set. Accordingly, the related procedure in TS38.321 is proposed to be updated as follows or the like:

```
“The MAC entity shall for each Serving Cell configured for beam failure
detection:
  1> if the Serving Cell is configured with two BFD-RS sets:
  2> if beam failure instance indication for a BFD-RS set has been received from
lower layers:
  3> start or restart the beamFailureDetectionTimer of the BFD-RS set;
  3> increment BFI_COUNTER of the BFD-RS set by 1;
  3> if BFI_COUNTER of the BFD-RS set >= beamFailureInstanceMaxCount:
  4> trigger a BFR for this BFD-RS set of the Serving Cell;
  2> if BFR is triggered for both BFD-RS sets of the SpCell and the Beam Failure
Recovery procedure is not successfully completed for any of the BFD-RS sets:
  3> initiate a Random Access procedure (see clause 5.1) on the SpCell;
  2> if the Serving Cell is SpCell and the Random Access procedure initiated for
beam failure recovery of both BFD-RS sets of SpCell is successfully completed (see
clause 5.1):
  3> set BFI_COUNTER of each BFD-RS set of SpCell to 0.
  3> consider the Beam Failure Recovery procedure successfully completed.
  2> if the beamFailureDetectionTimer of this BFD-RS set expires; or
  2> if beamFailureDetectionTimer, beamFailureInstanceMaxCount, or any of the
reference signals used for beam failure detection is reconfigured by upper layers or by
the BFD-RS Indication MAC CE associated with a BFD-RS set of the Serving Cell, or
the number of the reference signals used for beam failure detection associated with a
BFD-RS set of the Serving Cell is zero according to a DCI or a MAC CE activating TCI
states:
  3> set BFI_COUNTER of the BFD-RS set to 0.
  2> if a PDCCH addressed to C-RNTI indicating uplink grant for a new
transmission is received for the HARQ process used for the transmission of the
Enhanced BFR MAC CE or Truncated Enhanced BFR MAC CE which contains beam
failure recovery information of this BFD-RS set of the Serving Cell:
  3> set BFI_COUNTER of the BFD-RS set to 0;
  3> consider the Beam Failure Recovery procedure successfully completed for this
BFD-RS set and cancel all the triggered BFRs of this BFD-RS set of the Serving Cell.
  2> if the Serving Cell is SCell and the SCell is deactivated as specified in clause
5.9:
  3> set BFI_COUNTER of each BFD-RS set of SCell to 0;
  3> consider the Beam Failure Recovery procedure successfully completed and
cancel all the triggered BFRs of all BFD-RS sets of the Serving Cell.”
```

Similarly, according to some other embodiments of the present application, TRP-specific BFR is also still maintained. The determined one BFD-RS set is one of the two (or more) BFD-RS sets associated with the only one joint or downlink TCI state of the at least one joint or downlink TCI states and includes at least one RS determined according to the only one joint or downlink TCI state. Other BFD-RS sets of the two (or more) BFD-RS sets are not associated with the only one joint or downlink TCI state and include zero RS. In the case that the serving cell is a SpCell, the UE will fallback to a RACH-based BFR to recovery the link (and/or beam) if the BFD-RS set including a RS according to the only one joint or downlink TCI state is detected as a beam failure. That is, a random access procedure will be initiated on the serving cell in the case that a beam failure recovery procedure is triggered for the determined one BFD-RS set and the serving cell is a SpCell. Correspondingly, the gNB will detect a random access procedure on the serving cell in the case that a beam failure recovery procedure is triggered for the determined one BFD-RS set and the serving cell is a SpCell. The BFI counter of the BFD-RS set including no RS will be set (or reset) to 0. That is, the UE and gNB will stop the beam failure detection of the other BFD-RS set(s).

Accordingly, the related procedure in TS38.321 is proposed to be updated as follows:

```
“The MAC entity shall for each Serving Cell configured for beam failure
detection:
  1> if the Serving Cell is configured with two BFD-RS sets:
  2> if beam failure instance indication for a BFD-RS set has been received from
lower layers:
  3> start or restart the beamFailureDetectionTimer of the BFD-RS set;
  3> increment BFI_COUNTER of the BFD-RS set by 1;
  3> if BFI_COUNTER of the BFD-RS set >= beamFailureInstanceMaxCount:
  4> trigger a BFR for this BFD-RS set of the Serving Cell;
  2> if BFR is triggered for both BFD-RS sets of the SpCell and the Beam Failure
Recovery procedure is not successfully completed for any of the BFD-RS sets, or BFR is
triggered for one BFD-RS set of the SpCell and the number of the reference signals used
for beam failure detection associated with the other BFD-RS set is zero according to
according to a DCI or a MAC CE activating TCI states :
  3> initiate a Random Access procedure (see clause 5.1) on the SpCell;
  2> if the Serving Cell is SpCell and the Random Access procedure initiated for
beam failure recovery of both BFD-RS sets of SpCell is successfully completed (see
clause 5.1):
  3> set BFI_COUNTER of each BFD-RS set of SpCell to 0.
  3> consider the Beam Failure Recovery procedure successfully completed.
  2> if the beamFailureDetectionTimer of this BFD-RS set expires; or
  2> if beamFailureDetectionTimer, beamFailureInstanceMaxCount, or any of the
reference signals used for beam failure detection is reconfigured by upper layers or by
the BFD-RS Indication MAC CE associated with a BFD-RS set of the Serving Cell, or
the number of the reference signals used for beam failure detection associated with a
BFD-RS set of the Serving Cell is zero according to a DCI or a MAC CE activating TCI
states:
  3> set BFI_COUNTER of the BFD-RS set to 0.
  2> if a PDCCH addressed to C-RNTI indicating uplink grant for a new
transmission is received for the HARQ process used for the transmission of the
Enhanced BFR MAC CE or Truncated Enhanced BFR MAC CE which contains beam
failure recovery information of this BFD-RS set of the Serving Cell:
  3> set BFI_COUNTER of the BFD-RS set to 0;
  3> consider the Beam Failure Recovery procedure successfully completed for this
BFD-RS set and cancel all the triggered BFRs of this BFD-RS set of the Serving Cell.
  2> if the Serving Cell is SCell and the SCell is deactivated as specified in clause
5.9:
  3> set BFI_COUNTER of each BFD-RS set of SCell to 0;
  3> consider the Beam Failure Recovery procedure successfully completed and
cancel all the triggered BFRs of all BFD-RS sets of the Serving Cell.”
```

According to some yet other embodiments of the present application, dynamic switch between TRP-specific BFR and cell-specific BFR is supported, wherein implicit BFD-RS set determination is also applied for cell-specific BFR. In addition, it is assumed that the UE also has the capability of supporting cell-specific BFR besides TRP-specific BFR. However, only one of cell-specific BFR and TRP-specific BFR will be applied at the same time.

For NBI-RS set configuration of cell-specific BFR, it can be configured in various manners. For example, in some cases, one NBI-RS set is configured by RRC signaling for cell-specific BFR. The UE will be configured with three NBI-RS sets, wherein two NBI-RS sets are for TRP-specific BFR and one NBI-RS is for TRP-specific BFR. In some other cases, no NBI-RS set is configured by RRC signaling for cell-specific BFR, while the NBI-RS set for cell-specific BFR is determined as all RSs in the two NBI-RS sets configured for TRP-specific BFR implicitly. That is, the NBI-RS set for cell-specific BFR includes both the two NBI-RS sets configured for TRP-specific BFR. Besides, the maximum BFI count, e.g., beamFailureInstanceMaxCount, BFD timer, e.g., beamFailureDetectionTimer, BFR timer, e.g., beamFailureRecoveryTimer and BFI counter, e.g., BFI_COUNTER will be configured for cell-specific BFR, in spite of all these parameters already being configured for TRP-specific per BFD-RS set.

When only one joint or downlink TCI state is indicated by a DCI or a MAC CE for downlink channels or only one joint or downlink TCI state is applied for CORESETs in the BWP, the UE (or gNB) will switch to cell-specific BFR. A new BFD-RS set for cell-specific BFR will be determined, and cell-specific BFR will be performed. That is, the determined one BFD-RS set is different from any one of the two (or more) BFD-RS sets, each of the two or more BFD-RS sets includes zero RS. The BFI counters of the two (or more) BFD-RS of TRP-specific BFR will be set to 0. The UE will only perform a beam failure recovery procedure for the determined one BFD-RS set in the serving cell in a manner as the same as that performed in the case that only one BFD-RS set is configured in the serving cell (e.g., a legacy cell-specific BRF). Correspondingly, the gNB will only detect beam failure recovery report for the determined one BFD-RS set in the serving cell in a manner as the same as that performed in the case that only one BFD-RS set is configured in the serving cell (e.g., a legacy cell-specific BRF).

Although some embodiments of the present application are illustrated in view of the cases that the two joint or downlink TCI states are configured to be applied for different CORESETs, the illustrated technical solutions are also adaptive to the case that the same joint or downlink TCI state is configured to be applied for the CORESETs (that is, only one of the indicated joint or downlink TCI states is applied for the CORESETs or TRPs).

Besides methods of supporting beam failure recovery, some embodiments of the present application also provide an apparatus of supporting beam failure recovery.

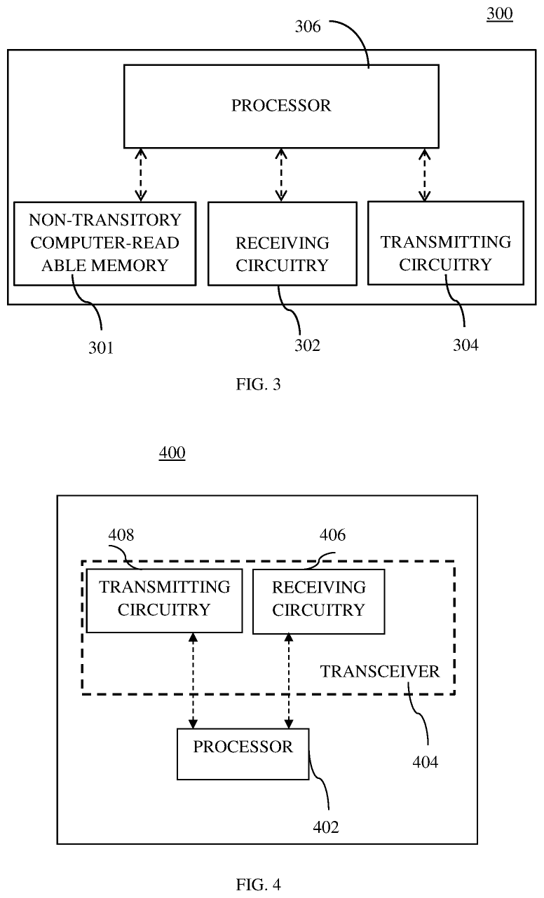

For example, FIG. 3 is a block diagram of an apparatus of supporting beam failure recovery according to some embodiments of the present application.

As shown in FIG. 3, the apparatus 300 may include at least one non-transitory computer-readable medium 301, at least one receiving circuitry 302, at least one transmitting circuitry 304, and at least one processor 306 coupled to the non-transitory computer-readable medium 301, the receiving circuitry 302 and the transmitting circuitry 304. The apparatus 300 may be a RAN node, e.g., a gNB or the like configured to perform a method illustrated in the above or the like. In some other embodiments of the present application, the apparatus 300 may be a remote apparatus, e.g., a UE or the like configured to perform a method illustrated in the above or the like

Although in this figure, elements such as the at least one processor 306, transmitting circuitry 304, and receiving circuitry 302 are described in the singular, the plural is contemplated unless a limitation to the singular is explicitly stated. In some embodiments of the present application, the receiving circuitry 302 and the transmitting circuitry 304 can be combined into a single device, such as a transceiver. The processor 306 may be a central processing unit (CPU), a digital signaling processing (DSP), a microprocessor etc. In certain embodiments of the present application, the apparatus 300 may further include an input device, a memory, and/or other components.

In some embodiments of the present application, the non-transitory computer-readable medium 301 may have stored thereon computer-executable instructions to cause the processor 306 to implement the method with respect to the RAN node as described above. For example, the computer-executable instructions, when executed, cause the processor 306 interacting with receiving circuitry 302 and transmitting circuitry 304, so as to perform the steps with respect to a gNB as depicted above.

In some embodiments of the present application, the non-transitory computer-readable medium 301 may have stored thereon computer-executable instructions to cause the processor 306 to implement the method with respect to the UE as described above. For example, the computer-executable instructions, when executed, cause the processor 306 interacting with receiving circuitry 302 and transmitting circuitry 304, so as to perform the steps with respect to a UE as depicted above.

FIG. 4 illustrates a block diagram of an apparatus 400 of supporting beam failure recovery according to some other embodiments of the present application.

Referring to FIG. 4, the apparatus 400, e.g., a gNB or a UE or the like may include at least one processor 402 and at least one transceiver 404. The transceiver 404 may include at least one separate receiving circuitry 406 and transmitting circuitry 408, or at least one integrated receiving circuitry 406 and transmitting circuitry 408. The at least one processor 402 may be a CPU, a DSP, a microprocessor etc.

According to some embodiments of the present application, when the apparatus 400 is a UE or the like, the processor is configured to: receive a signaling indicating at least one joint or downlink TCI state for downlink channel in a BWP of a serving cell, wherein two or more NBI-RS sets and two or more BFD-RS sets are configured in the BWP, the two or more NBI-RS sets and the two or more BFD-RS sets are one to one associated, and zero RS or at least one RS for each BFD-RS set will be determined from the at least one joint or downlink TCI state; and determine one BFD-RS set according to a joint or downlink TCI state of the at least one joint or downlink TCI state in the case that a number of the at least one joint or downlink TCI state is one or only the joint or downlink TCI state is applied for CORESETs in the BWP, wherein the determined one BFD-RS set is one of the two or more BFD-RS sets or different from any one of the two or more BFD-RS sets.

According to some other embodiments of the present application, when the apparatus 400 is a gNB or the like, the processor may be configured to: transmit a signaling indicating at least one joint or downlink TCI state for downlink channel in a BWP of a serving cell, wherein two or more NBI-RS sets and two or more BFD-RS sets are configured in the BWP, the two or more NBI-RS sets and the two or more BFD-RS sets are one to one associated, and zero RS or at least one RS for each BFD-RS set will be determined from the at least one joint or downlink TCI state; and determine one BFD-RS set according to a joint or downlink TCI state of the at least one joint or downlink TCI state in the case that a number of the at least one joint or downlink TCI state is one or only the joint or downlink TCI state is applied for CORESETs in the BWP, wherein the determined one BFD-RS set is one of the two or more BFD-RS sets or different from any one of the two or more BFD-RS sets.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device capable of implementing the flowcharts shown in the figures may be used to implement the processor functions of this application. For example, an embodiment of the present application provides an apparatus including a processor and a memory. Computer programmable instructions for implementing a method stored in the memory, and the processor is configured to perform the computer programmable instructions to implement the method. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as random access memory (RAMs), read only memory (ROMs), flash memory, electrically erasable programmable read only memory (EEPROMs), optical storage devices (compact disc (CD) or digital video disc (DVD)), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method as stated above or other method according to an embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

1. A wireless communication apparatus, comprising:
at least one memory; and
at least one processor coupled with the at least one memory and configured to cause the wireless communication apparatus to:
receive a signaling indicating at least one joint or downlink transmission configuration indication (TCI) state for downlink channel in a bandwidth part (BWP) of a serving cell, wherein two or more new beam indicator (NBI)-resource signal (RS) sets and two or more beam failure detection (BFD)-RS sets are configured in the BWP, the two or more NBI-RS sets and the two or more BFD-RS sets are one to one associated, and zero RS or at least one RS for each BFD-RS set will be determined from the at least one joint or downlink TCI state; and
determine one BFD-RS set according to a joint or downlink TCI state of the at least one joint or downlink TCI state in response to a number of the at least one joint or downlink TCI state being one or only the joint or downlink TCI state is applied for control resource sets (CORESETs) in the BWP, wherein the determined one BFD-RS set is one of the two or more BFD-RS sets or different from any one of the two or more BFD-RS sets.

2. The wireless communication apparatus of claim 1, wherein the at least one joint or downlink TCI state is associated with a same transmit receive point (TRP) or different TRPs, and different TRPs are associated with different BFD-RS sets of the two or more BFD-RS sets.

3. The wireless communication apparatus of claim 2, wherein each TRP is associated with a TCI state group or a CORESET group.

4. The wireless communication apparatus of claim 1, wherein the determined one BFD-RS set is one of the two or more BFD-RS sets associated with the joint or downlink TCI state and includes at least one RS determined according to the joint or downlink TCI state, other BFD-RS sets of the two or more BFD-RS sets are not associated with the joint or downlink TCI state and include zero RS, and the at least one processor is configured to cause the wireless communication apparatus to set beam failure instance (BFI) counters of the other BFD-RS sets to 0.

5. The wireless communication apparatus of claim 4, wherein the at least one processor is further configured to cause the wireless communication apparatus to perform a beam failure recovery procedure for the determined one BFD-RS set in a manner as the same as that performed in the case that response to each of the two or more BFD-RS sets being associated with an indicated TCI state.

6. The wireless communication apparatus of claim 1, wherein the determined one BFD-RS set is one of the two or more BFD-RS sets associated with the joint or downlink TCI state and includes at least one RS determined according to the joint or downlink TCI state, other BFD-RS sets of the two or more BFD-RS sets are not associated with the joint or downlink TCI state and include zero RS, and the at least one processor is configured to cause the wireless communication apparatus to initiate a random access procedure on the serving cell in response to a beam failure recovery procedure being triggered for the determined one BFD-RS set and the serving cell is a special cell (SpCell).

7. The wireless communication apparatus of claim 1, wherein the determined one BFD-RS set is different from any one of the two or more BFD-RS sets, each of the two or more BFD-RS sets includes zero RS, and the at least one processor is configured to cause the wireless communication apparatus to set beam failure instance (BFI) counters of the two or more BFD-RS sets to 0.

8. The wireless communication apparatus of claim 7, wherein the at least one processor is configured to cause the wireless communication apparatus to perform a beam failure recovery procedure for the determined one BFD-RS set in the serving cell in a manner as the same as that performed in response to only one BFD-RS set being configured in the serving cell.

9. A wireless communication apparatus, comprising:
at least one memory; and
at least one processor coupled with the at least one memory and configured to cause the wireless communication apparatus to:
transmit a signaling indicating at least one joint or downlink transmission configuration indication (TCI) state for downlink channel in a bandwidth part (BWP) of a serving cell, wherein two or more new beam indicator (NBI)-resource signal (RS) sets and two or more beam failure detection (BFD)-RS sets are configured in the BWP, the two or more NBI-RS sets and the two or more BFD-RS sets are one to one associated, and zero RS or at least one RS for each BFD-RS set will be determined from the at least one joint or downlink TCI state; and
determine one BFD-RS set according to a joint or downlink TCI state of the at least one joint or downlink TCI state in response to a number of the at least one joint or downlink TCI state being one or only the joint or downlink TCI state is applied for control resource sets (CORESETs) in the BWP, wherein the determined one BFD-RS set is one of the two or more BFD-RS sets or different from any one of the two or more BFD-RS sets.

10. The wireless communication apparatus of claim 9, wherein the at least one joint or downlink TCI state is associated with a same transmit receive point (TRP) or different TRPs, and different TRPs are associated with different BFD-RS sets of the two or more BFD-RS sets.

11. The wireless communication apparatus of claim 10, wherein each TRP is associated with a TCI state group or a CORESET group.

12. The wireless communication apparatus of claim 9, wherein the determined one BFD-RS set is one of the two or more BFD-RS sets associated with the joint or downlink TCI state and includes at least one RS determined according to the joint or downlink TCI state, other BFD-RS sets of the two or more BFD-RS sets are not associated with the joint or downlink TCI state and include zero RS, and the at least one processor is configured to cause the wireless communication apparatus to set beam failure instance (BFI) counters of the other BFD-RS sets to 0.

13. The wireless communication apparatus of claim 9, wherein the determined one BFD-RS set is one of the two or more BFD-RS sets associated with the joint or downlink TCI state and includes at least one RS determined according to the joint or downlink TCI state, other BFD-RS sets of the two or more BFD-RS sets are not associated with the joint or downlink TCI state and include zero RS, and the at least one processor is configured to cause the wireless communication apparatus to detect a random access procedure on the serving cell in response to a beam failure recovery procedure being triggered for the determined one BFD-RS set and the serving cell is a special cell (SpCell).

14. The wireless communication apparatus of claim 9, wherein the determined one BFD-RS set is different from any one of the two or more BFD-RS sets, each of the two or more BFD-RS sets includes zero RS, and the at least one processor is configured to cause the wireless communication apparatus to set beam failure instance (BFI) counters of the two or more BFD-RS sets to 0.

15. A method performed by a wireless communication apparatus, the method comprising:
receiving a signaling indicating at least one joint or downlink transmission configuration indication (TCI) state for downlink channel in a bandwidth part (BWP) of a serving cell, wherein two or more new beam indicator (NBI)-resource signal (RS) sets and two or more beam failure detection (BFD)-RS sets are configured in the BWP, the two or more NBI-RS sets and the two or more BFD-RS sets are one to one associated, and zero RS or at least one RS for each BFD-RS set will be determined from the at least one joint or downlink TCI state; and
determining one BFD-RS set according to a joint or downlink TCI state of the at least one joint or downlink TCI state in response to a number of the at least one joint or downlink TCI state being one or only the joint or downlink TCI state is applied for control resource sets (CORESETs) in the BWP, wherein the determined one BFD-RS set is one of the two or more BFD-RS sets or different from any one of the two or more BFD-RS sets.

16. A processor for wireless communication, comprising:
at least one controller coupled with at least one memory and configured to cause the processor to:
receive a signaling indicating at least one joint or downlink transmission configuration indication (TCI) state for downlink channel in a bandwidth part (BWP) of a serving cell, wherein two or more new beam indicator (NBI)-resource signal (RS) sets and two or more beam failure detection (BFD)-RS sets are configured in the BWP, the two or more NBI-RS sets and the two or more BFD-RS sets are one to one associated, and zero RS or at least one RS for each BFD-RS set will be determined from the at least one joint or downlink TCI state; and
determine one BFD-RS set according to a joint or downlink TCI state of the at least one joint or downlink TCI state in response to a number of the at least one joint or downlink TCI state being one or only the joint or downlink TCI state is applied for control resource sets (CORESETs) in the BWP, wherein the determined one BFD-RS set is one of the two or more BFD-RS sets or different from any one of the two or more BFD-RS sets.

17. The processor of claim 16, wherein the at least one joint or downlink TCI state is associated with a same transmit receive point (TRP) or different TRPs, and different TRPs are associated with different BFD-RS sets of the two or more BFD-RS sets.

18. The processor of claim 17, wherein each TRP is associated with a TCI state group or a CORESET group.

19. The processor of claim 16, wherein the determined one BFD-RS set is one of the two or more BFD-RS sets associated with the joint or downlink TCI state and includes at least one RS determined according to the joint or downlink TCI state, other BFD-RS sets of the two or more BFD-RS sets are not associated with the joint or downlink TCI state and include zero RS, and the at least one controller is configured to cause the processor to set beam failure instance (BFI) counters of the other BFD-RS sets to 0.

20. The processor of claim 19, wherein the at least one controller is configured to cause the processor to perform a beam failure recovery procedure for the determined one BFD-RS set in a manner as the same as that performed in response to each of the two or more BFD-RS sets being associated with an indicated TCI state.
